(19) United States
(12) Patent Application Publication
(10) Pub. No.: US 2009/0068321 A1
(43) Pub. Date: Mar. 12, 2009

(54) Ice cream cone end pastry

(76) Inventors: Jackie Clayton, Prescott, AZ (US); Patricia La Due, Blue Diamond, NV (US)

Correspondence Address: DEAN A. CRAINE, SUITE 140, 400 - 112TH AVENUE NE, BELLEVUE, WA, 98004, US

(21) Appl. No.: 12/283,547

(22) Filed: Sep. 12, 2008

Related U.S. Application Data
(60) Provisional application No. 60/993,688, filed on Sep. 12, 2007.

(51) Int. Cl. A23G 9/50; B65D 85/78

(52) U.S. Cl. 426/101; 426/130; 426/124

(57) ABSTRACT

A frozen ice cream pastry that includes the tip or closed end section of a conical or cylindrical-shaped ice cream cone, respectively, that is filled with ice cream. In the preferred embodiment, the top surface of the ice cream is flat with the top edge of the cone. The cone can be made of cake or waffle ingredients. The pastry may or may not be covered with a chocolate layer. In one embodiment, the pastry is sold in a protective cardboard container that includes an inner protective carrier with a plurality of cone-shaped cutouts formed therein. The pastry is then placed into a cutout and individually removed from the carrier when desired. In another embodiment, a small serving of pastries are sold in an air filled bag which when removed from the freezer are consumed. In still another embodiment, a plurality of air filled bags each filled with one serving of pastries are sold and distributed in a large container which may be stored in the freezer.

This is a utility patent application which claims benefit of U.S. Provisional Application No. 60/993,688 filed on Sep. 12, 2007.

### BACKGROUND OF THE INVENTION

1. Field of the Invention

This invention pertains to food products, and more particularly to pre-manufactured, bite-size frozen pastries distributed in protective packaging.

2. Description of the Related Art

Food manufacturers are constantly looking for new, innovative snack or treat products. Frozen snacks and treats, such as popsicles, fudge bars, ice cream sandwiches, are still popular but have lost some of their pizzazz or “wow” factor. New product that can provide pizzazz or excitement in this sector of food products are especially desirable.

Well known bonbons are spherical, bite-size, frozen pieces of ice cream covered with a layer of chocolate. A small quantity of bonbons (i.e. 8 to 12 pieces) are commonly sold in small packages which are opened for immediate consumption.

Ice cream cones are another popular frozen treat or snack that are normally prepared individually in restaurants or homes just prior to consumption. The cone-shaped pastry, referred to as a cone, is removed individually from a large, protective cardboard or foam container that holds a large quantity of cones. Frozen ice cream is then scooped from a large container or dispensed from a soft ice cream dispenser into the cone. The ice cream fills the cone and extends above the top edge so that it may be easily bitten or licked by the consumer. Today, pre-manufactured, individually wrapped ice cream cones are sold in large cardboard packages.

There are two general styles of cones—a flat bottom cone and a pointed end cone. Normally, the flat bottom cones are made of lightweight, crunchy wafer material while the pointed end cones are made of more rigid, sweeter material (often called a ‘sugar cone’). The end of the cones are normally closed and usually filled with melted ice cream by the time they are consumed. Because the ice cream settles into the end of the cone and because the end is usually the most favorable part of the cone, many individuals consider the end or tip of an ice cream cone their favorite section.

What is needed is a new, innovative frozen bite-size dessert or treat product that appeals both to consumers of bonbons and to ice cream cone lovers.

### SUMMARY OF THE INVENTION

The above referenced object is met by the frozen ice cream cone pastry disclosed herein that includes the tip or end section of a conical or cylindrical-shaped ice cream cone, respectively, that is filled with frozen ice cream. Unlike a standard ice cream cone, the ice cream is only filled to the top edge of the cone so that substantially all of the ice cream is protected by the cone. In one embodiment, an edible, thin protective top layer is placed over the exposed top surface of the ice cream to help seal the ice cream inside the cone and to provide additional flavoring. The protective layer may be made of cake or waffle cone ingredients used to make the cone. The protective layer and/or the entire cone may also be covered with a chocolate layer.

In the one embodiment, the pastry is sold in a protective outer container that may include an inner protective carrier with a plurality of cylindrical or cone-shaped cutouts formed therein. During assembly, one compatible-shaped pastry is placed into each cutout. A means for removing each pastry from the cutout formed is also provided. A removable transparent film is then placed over the protective carrier to keep the confections fresh, cold and uncontaminated. The carrier is then placed into the outer container and shipped to retail outlets or customers.

In another embodiment, a plurality of pastries is loosely placed inside a small sealed bag that is filled with air. Typically, the sealed bags is designed to hold one serving (4 to 10 pastries). The bag made be distributed and sold individually or distributed and sold with a plurality of other sealed bags in a larger container. The large container may be kept in the freezer so that the individual bags may be individually removed from the large container as desired.

### DESCRIPTION OF THE DRAWINGS

FIG. 1 is a perspective view of the outer container that houses a plurality of cylindrical-shaped, frozen ice cream cone pastries located in a protective carrier.

FIG. 2 is a perspective of the protective carrier with a plurality of cylindrical-shaped cutouts formed therein, each designed to receive one cylindrical-shaped, frozen ice cream cone pastries with a transparent film being partially removed so that two pastries can be removed from the protective carrier.

FIG. 3 is a perspective view of the outer container that houses a plurality of conical-shaped, frozen ice cream cone pastries located in a protective carrier.

FIG. 4 is a perspective of the protective carrier with a plurality of conical-shaped cutouts formed therein, each designed to receive one conical-shaped, frozen ice cream cone pastries with a transparent film being partially removed so that two pastries can be removed from the protective carrier.

FIG. 5 is a sectional side elevational view of a cylindrical-shaped, frozen ice cream cone pastry.

FIG. 6 is a sectional side elevational view of a conical-shaped, frozen ice cream cone pastry.

FIG. 7 is an illustration showing one bag being removed from a large container containing a plurality of bags.

### DESCRIPTION OF THE PREFERRED EMBODIMENT(S)

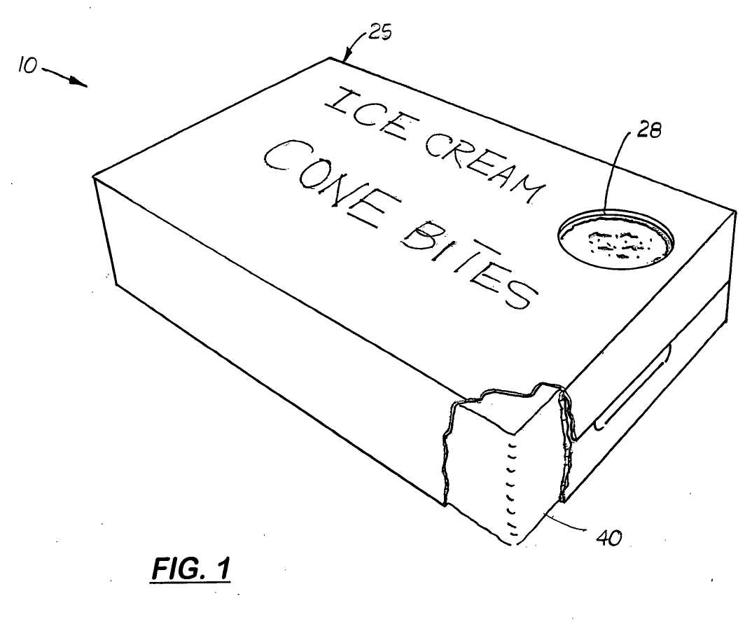

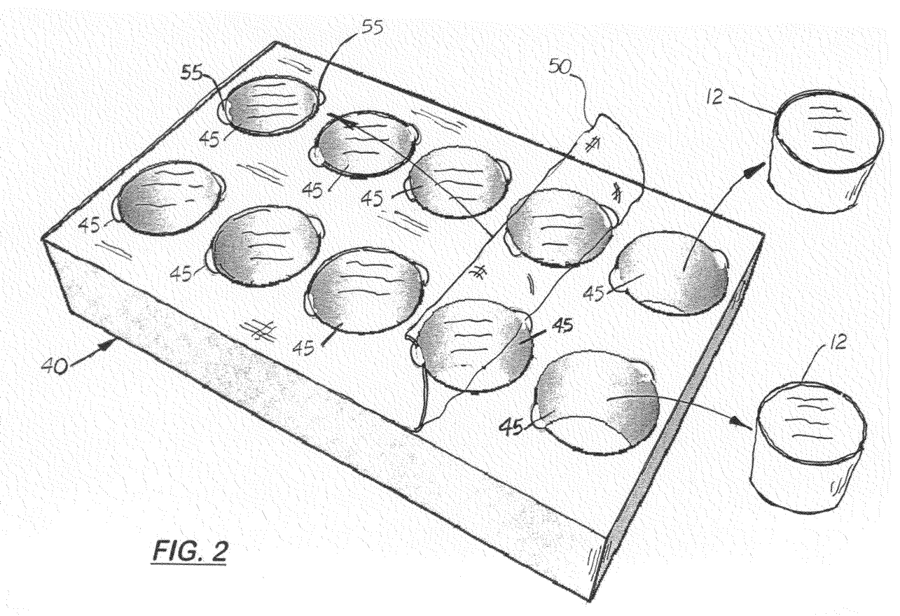

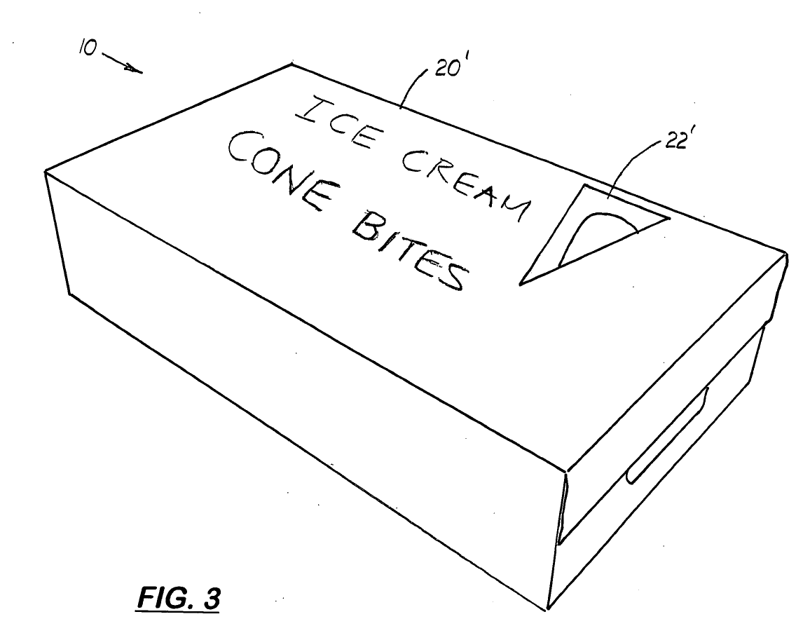

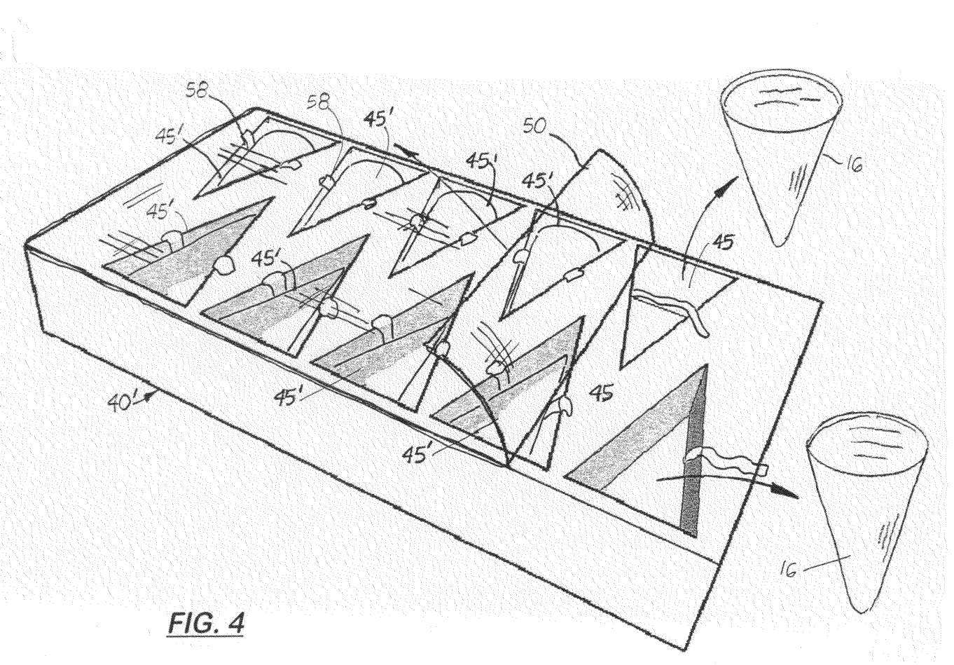

Referring to the accompanying FIGS. 1-7, there is shown a frozen ice cream product disclosed herein that includes an enclosed end section of a cylindrical-shaped ice cream cone 12 or a conical-shaped ice cream cone 16, respectively, filled with a desired flavor of ice cream 14. In the first embodiment, a plurality of pastries 12, 16 are sold in a protective cardboard outer container 25 or 25′ that houses an inner protective carrier 40 or 40′, respectively, with a plurality of compatible-shaped cutouts 45 or 45′, respectively, formed therein. The ice cream cone shaped pastries 12 or 16 are filled with frozen ice cream 14 or 18, respectively, and is placed into each cutout 45, 45′ formed on the carrier 40, 40′. The top surface of the carrier 40, 40′ and the pastries 12, 16 are then covered with a transparent, protective film 50. As shown in FIGS. 2 and 4, the protective film 50 is pulled backwards along one edge so that individual pastries 12, 16 may be selectively removed from the carrier 40 or 40′.

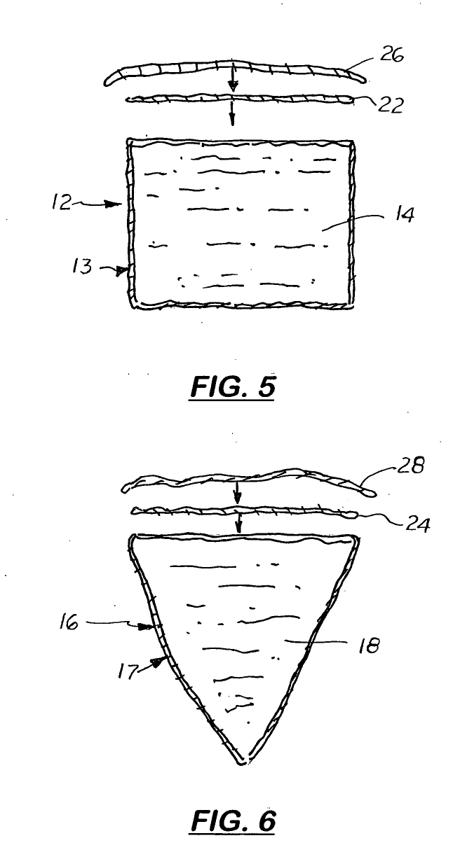

As shown in FIGS. 5 and 6, there are two types of pastries. The first pastry 12 includes an outer cone body 13 that simulates the lower section of a cylindrical-shaped ice cream cone with a flat closed end. The second pastry 18 includes an outer cone body 17 that simulates the lower section of a conical-shaped ice cream cone. Each cone body 13 or 17 is hollow so that ice cream 14 or 18, respectively, may be filled to the top opening. Formed over the top opening is a flat, top layer 22, 24, respectively. The cone bodies 13 or 17 and the top layers 22, 24, respectively, are made of a standard cake cone or waffle cone ingredients. When the ice cream 14 and the top layers 22, 24 have been added, a chocolate or caramel layer 26, 28 may be placed over the surface of the top layer 22, 24, respectively.

In the first embodiment, the outer container 25, 25′ includes an optional viewing window 28, 28′ which allows one pastry located immediately below the window 28, 28′ to be seen.

Each pastry 12, 16 are approximately ¾ to 2 inches in diameter and ¾ to 2 inches in length. The outer container 25, 25′ is made of cardboard and approximately 8 to 10 inches in length, 3 inches in width, and 1½ inches in height. The protective carriers 40, 40′ are slightly smaller then the outer containers 25, 25′, respectively, and made of cardboard or Styrofoam.

The formed around each cutout 45, 45′ on the protective carrier 40, 40′ is an optional means for removing the confection from the cutout 45, 45′. In one embodiment shown in FIG. 2, the means for removing is a recessed finger cavity 55 formed along the upper edge of the cutout 45 or 45′. In the second embodiment, shown in FIG. 4, the means for removing is a pull string 58 that extends into the cutout 45, 45′ and under the confection which, when pulled, lifts the confection from the cutout 45, 45′, respectively.

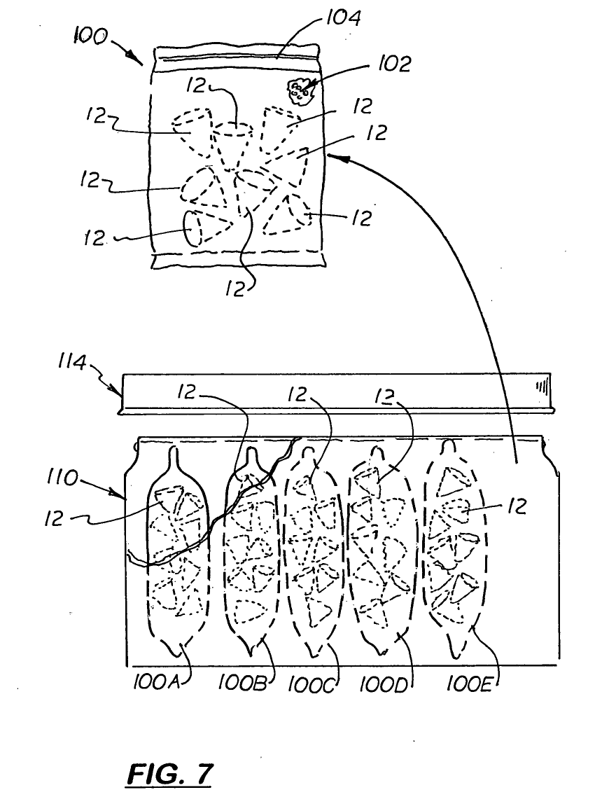

In another embodiment shown in FIG. 7, a plurality of pastries 12 is loosely packaged into a small sealed bag 100 filled with excessive air 102 designed to prevent the sides of the bag 100 from compacting during shipment. Typically, one serving (4 to 10 pastries) is placed inside each bag 100. Each bag 100 may include a re-sealable edge 104 enabling the bag 100 to be selectively closed after being opened by the consumer. The bag 100 is made be distributed and sold individually or sold with a plurality of other sealed bags 100A-100D in a larger container 110. Large container 110 may be kept in the freezer and may include a closable lid 114 that allows the individual bags 100, 100′, 100″ to be selectively removed from the larger container 110 as desired.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

We claim:

1. A frozen ice cream pastry comprising:
a. a plurality of closed end ice cream cone made of edible material, each said cone includes an upper top edge and a closed tip;
b. a volume of frozen ice cream placed inside said cone; and,
c. an outer container capable of holding all of said ice cream cone pastries.

2. The ice cream pastry, as recited in claim 1, wherein each said pastry includes a edible top layer placed over the exposed layer of ice cream.

3. The ice cream pastry, as recited in claim 2, wherein each said pastry is covered by a layer of chocolate.

4. The ice cream pastry, as recited in claim 1, wherein said top layer is made of cone material.

5. The ice cream pastry, as recited in claim 1, wherein said outer container is a sealed bag filled with sufficient amount of air to protect said pastries located inside said bag.

6. The ice cream pastry, as recited in claim 1, wherein said bag includes a re-sealable edge.

7. The ice cream pastry, as recited in claim 5, wherein each said pastry includes a edible top layer.

8. The ice cream pastry, as recited in claim 7, wherein each said pastry is covered by a layer of chocolate.

9. A frozen ice cream pastry comprising:
a. a plurality of closed end ice cream cone made of edible material, each said cone includes an upper top edge and a closed tip;
b. a volume of frozen ice cream placed inside said cone; and,
c. an outer container capable of holding all of said ice cream cone pastries.
